(19) United States
(12) Patent Application Publication
(10) Pub. No.: US 2014/0173316 A1
(43) Pub. Date: Jun. 19, 2014

(54) COMPUTER MAINBOARD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: SHENG-CUN ZHENG, Shenzhen (CN); HE-DONG LV, Shenzhen (CN); AN-LIN ZHOU, Shenzhen (CN)

(21) Appl. No.: 13/921,216

(22) Filed: Jun. 19, 2013

(30) Foreign Application Priority Data
Dec. 18, 2012 (CN) 2012105498230

(51) Int. Cl. G06F 1/26

(52) U.S. Cl. CPC G06F 1/26
USPC 713/330

(57) ABSTRACT

A delay circuit for power sequencing in a computer includes an oscillator; an input pin; a counter; a register; and a comparing controller. The counter detects a voltage of the input pin when each clock signal arrives, resets a number counted by the counter when the voltage of the input pin is detected at logic-low electrical level, and adds a predetermined number when the voltage of the input pin is detected at logic-high electrical level. The controller compares the total number counted by the counter with a preset number, and outputs a control signal when the numbers match. The control signal controls a connected logic circuit to work according to a power sequence.

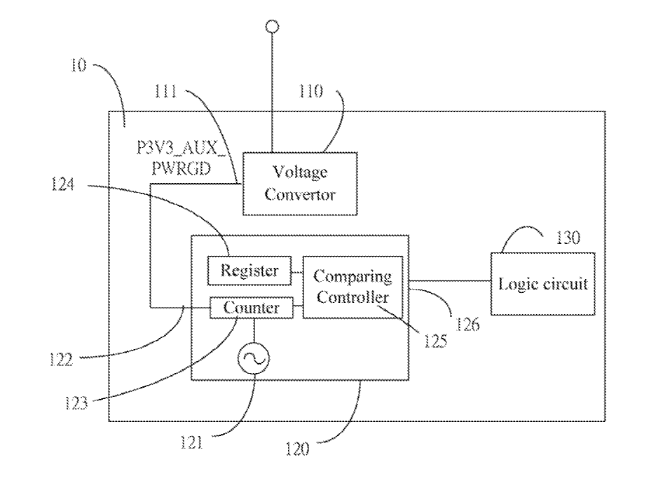

### BACKGROUND

1. Technical Field

The present disclosure relates to computer mainboards and, more particularly, to a computer mainboard which delays power sequencing using a CPLD (complex programable logic device) in the computer mainboard.

2. Description of Related Art

A computer mainboard uses a special delay circuit to delay power sequencing, however the special circuit increases cost.

Therefore, it is desirable to provide a computer mainboard which delays power sequencing using a CPLD in the computer mainboard.

### BRIEF DESCRIPTION OF THE DRAWING

The drawing is a schematic diagram showing a computer mainboard in an embodiment.

### DETAILED DESCRIPTION

Embodiments of the disclosure will be described with reference to the drawing.

Referring to the drawing, a computer mainboard 10 includes a voltage convertor 110, a CPLD (complex programable logic device) 120 and a logic circuit 130.

The voltage convertor 110 converts a stand-by voltage after the computer mainboard 10 is powered on. The voltage convertor 110 includes a power-good pin (P3V3_AUX_PWRGD pin) 111 to output a logic-high signal after the stand-by voltage is normal, that is, after the stand-by voltage outputs steadily.

The CPLD 120 includes an oscillator 121, an input pin 122, a counter 123, a register 124, a comparing controller 125, and an output pin 126. The oscillator 121 generates clock signals. The input pin 122 is connected to the power-good pin 111. The counter 123 detects a voltage of the input pin 122 when each clock signal arrives. If a logic-low voltage of the input pin 122 is detected, a number counted by the counter 123 is reset. If a logic-high voltage of the input pin 122 is detected, the number counted by the counter 123 is incremented by one.

The register 124 stores a preset number. The comparing controller 125 compares the number counted by the counter 123 with the preset number, and outputs a control signal when the number counted by the counter 123 is same as the preset number. The control signal is always a logic-high electrical level. The control signal controls the logic circuit 130 to work according to a power sequence. For example, the control signal may be a reset signal to reset the logic circuit 130.

The computer mainboard 10 delays the power sequencing using the CPLD 120 in each computer mainboard 10, without the need for a special delay circuit, decreasing cost.

The computer mainboard 10 may be used in personal computer or server.

The CPLD 120 is widely used in the computer mainboard 10. The CPLD 120 includes an oscillator, a random access memory (RAM), and a number of input pins and output pins. The CPLD 120 may be programmed to select some of the number of input pins and output pins and set a selected input pin and output pin as the input pin 122 and the output pin 126.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A computer mainboard comprising:
a voltage convertor, to convert a stand-by voltage after the computer mainboard is powered on, the voltage convertor comprising a power-good pin to output a logic-high electrical level after the stand-by voltage is normal;
a logic circuit; and
a complex programable logic device CPLD comprising:
an oscillator to generate clock signals;
an input pin connected with the power-good pin;
a counter, to detect a voltage of the input pin when each clock signal arrives, reset a number counted by the counter when the voltage of the input pin is detected at logic-low electrical level, and add a predetermined number when the voltage of the input pin is detected at logic-high electrical level;
a register, to store a preset number; and
a comparing controller, to compare the number counted by the counter with the preset number, and output a control signal when the number counted by the counter is same as the preset number, wherein the control signal is used to control the logic circuit to work according to a power sequence.

2. The computer mainboard according to claim 1, wherein the control signal is a logic-high electrical level.

3. The computer mainboard according to claim 1, wherein the control signal is a reset signal to reset the logic circuit.

4. The computer mainboard according to claim 1, wherein the CPLD comprises an oscillator, a random access memory RAM, several input pins and output pins, the CPLD is programmed to select some of the several input pins and output pins and set a selected input pin and output pin as the input pin and the output pin.

5. The computer mainboard according to claim 1, wherein the predetermined number is 1.

6. A delay circuit used in a complex programable logic device CPLD, connected with a voltage convertor which is used to convert a stand-by voltage after a computer mainboard is powered on, and comprises output a logic-high electrical level after the stand-by voltage is normal, the delay circuit comprising:
an oscillator to generate clock signals;
an input pin connected with a power-good pin;
a counter, to detect a voltage of the input pin when each clock signal arrives, reset a number counted by the counter when the voltage of the input pin is detected at logic-low electrical level, and add a predetermined number when the voltage of the input pin is detected at logic-high electrical level;
a register, to store a preset number; and
a comparing controller, to compare the number counted by the counter with the preset number, and output a control signal when the number counted by the counter is same as the preset number, wherein the control signal is used to control a logic circuit connected with the delay circuit to work according to a power sequence.

7. The delay circuit according to claim 6, wherein the control signal is a logic-high electrical level.

8. The delay circuit according to claim 6, wherein the control signal is a reset signal to reset the logic circuit.

9. The delay circuit according to claim 6, wherein the CPLD comprises an oscillator, a random access memory RAM, several input pins and output pins, the CPLD is programmed to select some of the several input pins and output pins and set a selected input pin and output pin as the input pin and the output pin.

10. The delay circuit according to claim 6, wherein the predetermined number is 1.
